(19) United States
(12) Patent Application Publication
(10) Pub. No.: US 2024/0383413 A1
(43) Pub. Date: Nov. 21, 2024

(54) TOOLBOX AND METHOD OF MOUNTING TO TAILGATE

(71) Applicant: Gopher Boxes, LLC, Mountain Grove, MO (US)

(72) Inventor: Zachary Martin, Mountain Grove, MO (US)

(21) Appl. No.: 18/544,600

(22) Filed: Dec. 19, 2023

Related U.S. Application Data
(60) Provisional application No. 63/502,173, filed on May 15, 2023.

(51) Int. Cl. B60R 11/06; B65D 1/34; B65D 1/40; B65D 25/10; B65D 43/16; B65D 43/22; B65D 55/02

(52) U.S. Cl. CPC B60R 11/06; B65D 1/34; B65D 1/40; B65D 25/10; B65D 43/16; B65D 43/22; B65D 55/02; B60R 2011/004; B65D 2251/1058; B65D 2543/00194

(57) ABSTRACT

A system and method for attaching a multi-use box to a vehicle. The multi-use box includes a base portion and a lid pivotally attached thereto, with dense foam therein, having cut-outs shaped like tools to be secured therein. The method may include aligning the base portion against an interior tailgate cover of a tailgate such that a perimeter of the base portion completely resides inward of a perimeter of the tailgate. The method may include pivoting open the lid and placing fasteners through holes formed through the base portion and holes of the interior tailgate cover aligned with the holes of the base portion. Furthermore, the method may include securing tools within the cutouts and pivoting the lid to a closed position, as well as pivoting the tailgate into an upright position such that the multi-use box is within a bed of the vehicle.

### RELATED APPLICATIONS

The present application is a non-provisional patent application and claims priority of co-pending U.S. Provisional Patent Application Ser. No. 63/502,173, filed on May 15, 2023, and entitled “TOOLBOX AND METHOD OF MOUNTING TO TAILGATE”, which is hereby incorporated in its entirety by reference herein.

### FIELD

The present invention relates to tool storage, toolboxes, and methods of mounting to a truck or vehicle.

### BACKGROUND

When drivers of pick-up trucks travel with smaller gear, such as hand tools, firearms, or fishing gear, it can be a challenge to keep these items secure and organized. While toolboxes are available, they are often prone to sliding around in the cab or the bed of the pick-up truck, which can cause damage to the toolbox itself or even cause injury to drivers and passengers in the cab. Furthermore, reaching such a toolbox when it slides around in the cab or the bed of the pick-up truck can be inconvenient, particularly if it slides to a hard-to-reach location during transport.

Therefore, there is a need for a system and method for securing smaller items for transport in a vehicle that does not suffer from these and other deficiencies of the prior art.

### SUMMARY OF THE INVENTION

In one or more embodiments herein, the present invention is a multi-use box made from a rigid material (e.g., steel or aluminum) that is watertight and is filled with dense foam that can be manipulated by the end user to insert tools, firearms, fishing gear, or other items that might benefit from watertight organized storage. Advantageously, for the purpose of tools, having this box mounted in the tailgate of a truck creates a tremendous benefit to the user by keeping their tools handy and organized as well as displaying what tool is missing. The foam also protects the items that have been inserted into it.

In some embodiments, a method for attaching a multi-use box to a vehicle includes aligning a base portion of the multi-use box against an interior tailgate cover of a tailgate such that a perimeter of the base portion completely resides inward of a perimeter of the tailgate. The method may include pivoting open a lid of the multi-use box and placing fasteners through holes formed through the base portion and holes of the interior tailgate cover aligned with the holes of the base portion. Furthermore, the method may include securing tools within the multi-use box (e.g., cutouts formed into a dense foam within the base portion) and pivoting the lid to a closed position. The method may also include pivoting the tailgate into an upright position such that the multi-use box is within a bed of the vehicle.

This summary is intended to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in more detail below with reference to the attached drawing figures, wherein:

FIG. 1A is a perspective view of a multi-use box, constructed in accordance with various embodiments of the present invention, for organizing and securing small items to a vehicle;

FIG. 1B is a top plan view of the multi-use box of FIG. 1A;

FIG. 1C is a side elevation view of the multi-use box of FIG. 1A;

FIG. 1D is an end elevation view of the multi-use box of FIG. 1A;

FIG. 1E is a back elevation view of the multi-use box of FIG. 1A;

FIG. 2 is a perspective view of the multi-use box of FIG. 1A attached to a vehicle, with a tailgate thereof in an upright orientation, in accordance with various embodiments of the present invention;

FIG. 3 is a perspective view of the multi-use box and the vehicle of FIG. 2, with the tailgate in a laid-out orientation, in accordance with various embodiments of the present invention;

FIG. 4 is a fragmentary perspective view of the vehicle and the multi-use box of FIG. 3, with the tailgate in the laid-out orientation and a lid of the multi-use box in an open position, in accordance with various embodiments of the present invention;

FIG. 5 is a fragmentary perspective view of the vehicle and the multi-use box of FIG. 4, with a tool removed from a cutout shaped like that tool in dense foam within the multi-use box, in accordance with various embodiments of the present invention; and

FIG. 6 is a flow chart of a method of configuring and/or mounting the multi-use box to the tailgate, in accordance with various embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized, and changes can be made without departing from the scope of the current invention. The following detailed description is, therefore, not to be taken in a limiting sense. The scope of the current invention is defined only by the appended claims, along with the full scope of equivalents to which such claims are entitled.

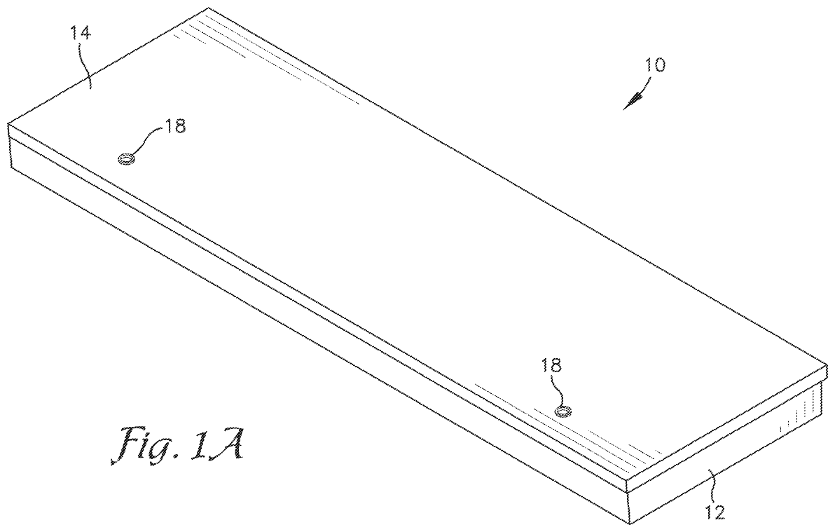

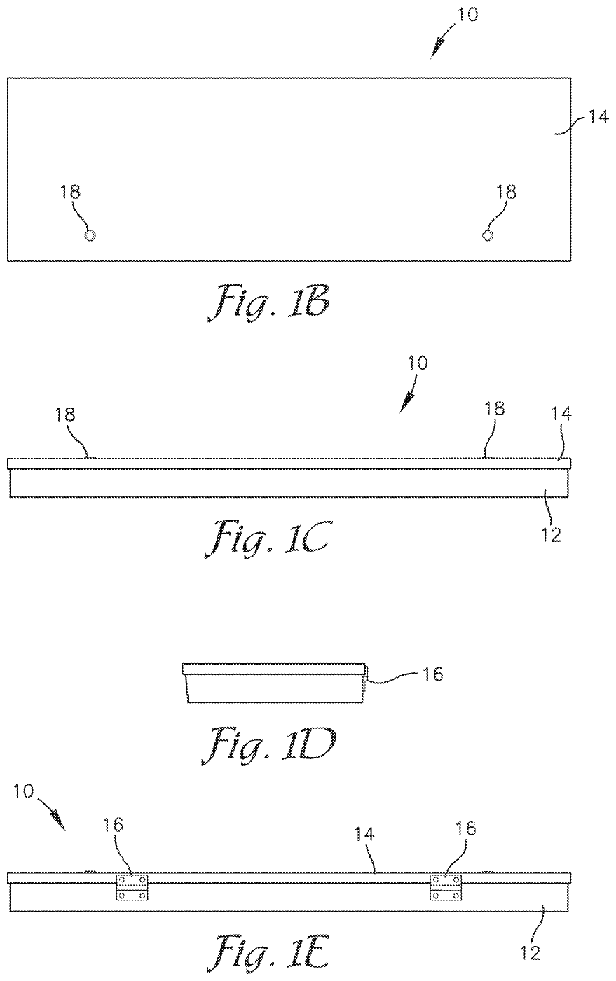

The present invention, as depicted in FIGS. 1A-1D and FIGS. 2-5, includes a multi-use box 10 made from a rigid material such as steel or aluminum. The multi-use box 10 includes a base portion 12 with a bottom wall and multiple side walls, as well as a lid 14 pivotally connected to the base portion 12. For example, as depicted in FIG. 1E, the lid 14 may be pivotally connected to the base portion 12 via a hinge 16 (e.g., a mechanical hinge, or a living hinge formed along a thin line of weakness formed between one of the side walls of the base portion 12 and the lid 14).

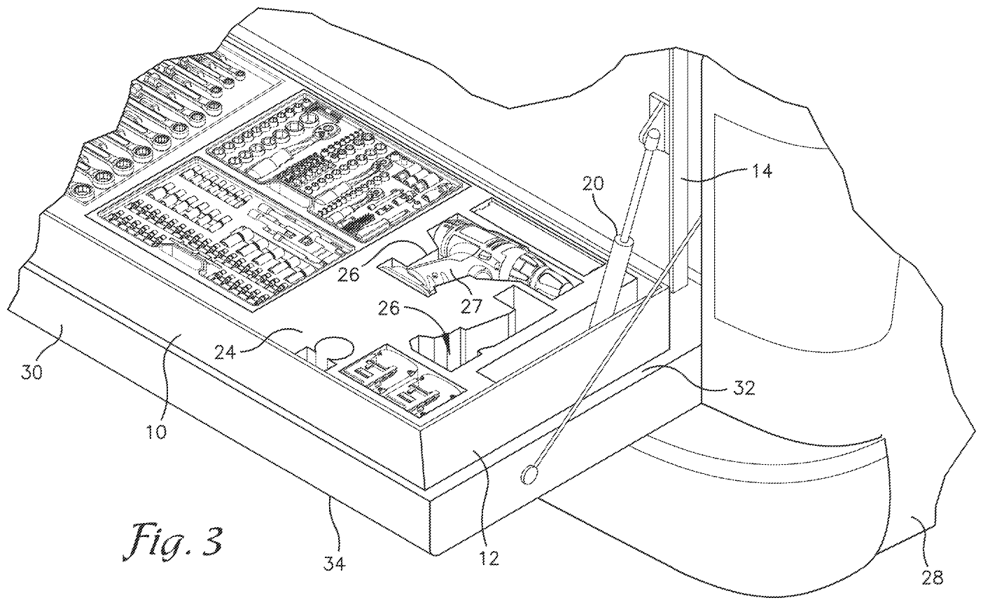

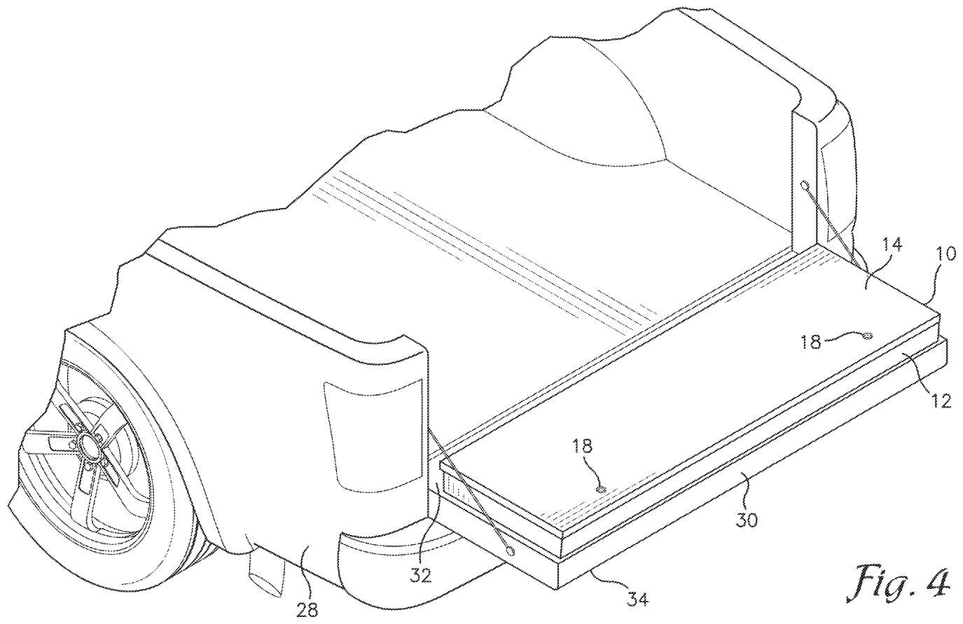

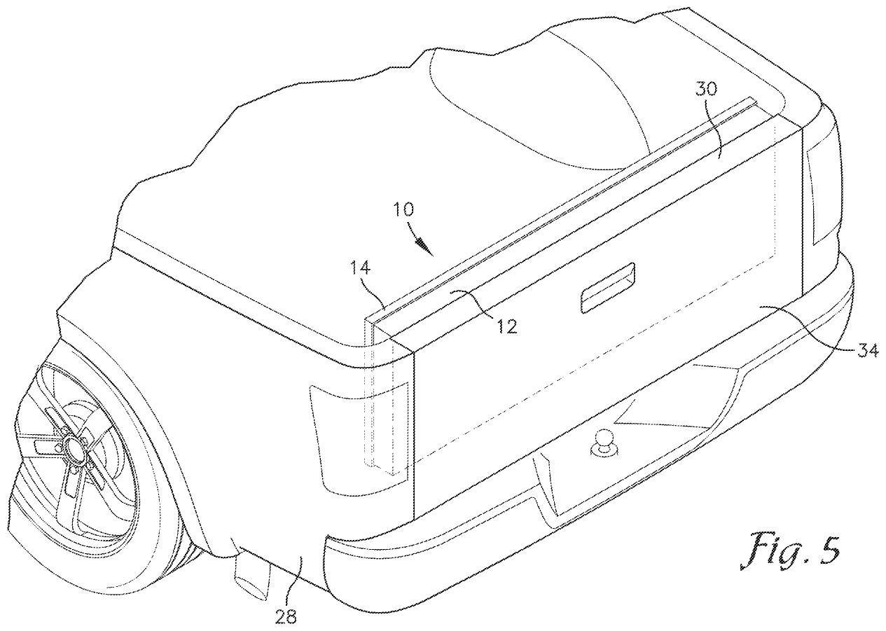

As depicted in FIGS. 1A, 3, and 4, the multi-use box 10 may also include one or more latches 18, locks, or the like for maintaining the lid 14 in a closed position or, when unlatched or unlocked, allowing the lid 14 to be pivoted from a closed position, as in FIG. 3, into an open position, as depicted in FIG. 4. Furthermore, as depicted in FIGS. 4-5, one or more embodiments of the invention may also include one or more pneumatic springs 20, which assist in holding the lid 14 in the open position and provide pneumatic resistance such that the lid 14 must be pressed with a sufficient closing force in order to close it. This can avoid the lid 14 inadvertently closing while a person's hands are reaching inside for a tool or the like from the multi-use box 10.

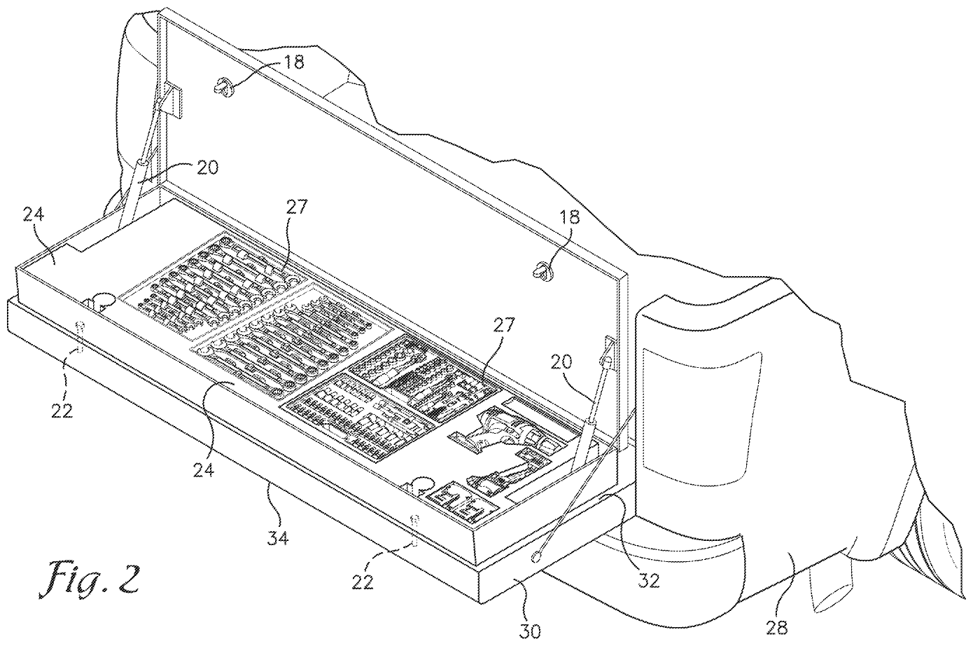

As depicted in FIGS. 2-3, the multi-purpose box 10 further includes mounting fasteners 22 and a dense foam 24. The mounting fasteners 22 may include screws, bolts, or other mounting fasteners. In some embodiments, the mounting fasteners 22 may be original fasteners or screws holding together components of the tailgate, for example, as later described herein. However, in embodiments where different mounting fasteners 22 are used than the original fasteners, the mounting fasteners 22 may be longer and stronger than the original fasteners or screws, as later described herein, to provide more secure attachment/mounting. In some embodiments, the multi-purpose box 10 is water-tight when in the closed position (such as via a seal, not shown, between the base portion 12 and the lid 14). In such embodiments, the mounting fasteners 22 may be configured for watertight attachment and thus include a seal, rubber O-ring, or the like.

The dense foam 24 may include, for example, one or more laminated dense foam inserts manufactured by KAIZEN FOAM INSERTS located in Wallingford, CT. In some embodiments, different ones of the foam insert may be selectively inserted into the multi-use box 10 in order to reconfigure the multi-use box 10 for different purposes or tools. In one or more embodiments, the dense foam 24 has formed therein cutouts 26 shaped, sized, and configured for securing particular tools, firearms, fishing gear, or the like. In other embodiments, the multi-use box 10 is filled with dense foam and the cutouts 26 can be formed thereinto via cutting tools, such that the dense foam's cutouts 26 are customizable for each purchaser's own specific purposes and needs.

As depicted in FIGS. 2-5, the multi-purpose box 10 can be configured for storing tools 27 (as depicted in FIGS. 2-3), firearms, fishing gear, or other items in a vehicle 28, such as a pick-up truck. In some embodiments, the multi-purpose box 10 is specifically configured for attachment to a tailgate 30 of the vehicle 28 or some other pivotable vehicle component, such as a door, a trunk lid, a hatchback, or the like. In example embodiments depicted in FIGS. 2-5, the tailgate 30 includes an interior tailgate cover 32 and an outer tailgate cover 34. For example, the original fasteners (e.g., mechanical fasteners, screws, bolts, etc.) located through at least a portion of the tailgate 30 are traditionally used to maintain the interior tailgate cover 32 over interior mechanisms (not shown) coupled to a handle of the tailgate 30 and/or to cover other such mechanisms within the tailgate 30 for maintaining the tailgate 30 in an upright orientation (as in FIG. 5) and likewise releasing the tailgate 30 to pivot downward into a laid-out orientation (as in FIGS. 2-4). Thus, in order to provide for the original fasteners, the interior tailgate cover 32 may have one or more or two or more fastener holes formed therethrough for insertion of the original fasteners and/or the mounting fasteners 22. The tailgate 30 in the upright orientation may be substantially perpendicular relative to the laid-out orientation. The outer tailgate cover 34 is traditionally located opposite the interior tailgate cover 32, with the interior mechanisms located between the interior tailgate cover 32 and the outer tailgate cover 34. The multi-use box may also include screws or other mounting fasteners or, in some embodiments, may use existing holes and screws originally included on the tailgate for such mounting purposes, as later described herein.

The multi-use box 10 is mountable on the tailgate 30 or other such vehicle doors or structures to advantageously allow the user to keep the tools 27 or the like handy and organized, as well as providing a visual of what tool or other storable item is missing via the shape of the cutouts 26 that remain empty, as depicted in FIG. 3. The dense foam 24 also advantageously protects the tools 27, or other such items inserted thereinto. Furthermore, the multi-use box 10 may have a thin profile, such as one to twelve inches in depth, two to eight inches in depth, or three to six inches in depth. However, other depths may be used without departing from the scope of the invention. A length and width of the multi-use box 10 may each be the same or less than a length and width of the tailgate 30, such that the multi-use box 10 does not impede opening or closing of the tailgate 30 (or other kinds of doors, trunk lids, hatchbacks, etc.) and is selectably located within the vehicle 28 (e.g., such as in a bed of a pick-up truck) when the tailgate 30 or the like is closed or in the upright orientation. However, other sizes and shapes than those depicted here may be used for the multi-use box 10 without departing from the scope of the invention.

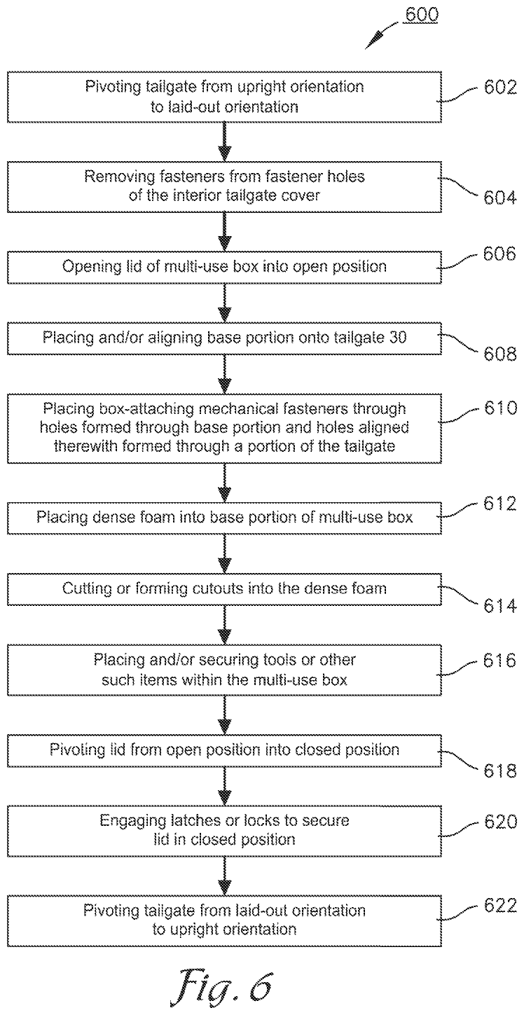

The flow chart of FIG. 6 depicts in more detail the steps of an exemplary method 600 of installing the multi-use box 10 onto the tailgate of a truck or other such vehicle (such as a trailer tailgate, a sports utility vehicle tailgate, or a hatchback tailgate), according to one or more embodiments of the present invention. In some embodiments of the invention, various steps may be omitted and/or steps may occur out of the order depicted in FIG. 6 without departing from the scope of the invention. For example, two blocks shown in succession in FIG. 6 may in fact be executed substantially concurrently, or blocks may sometimes be executed in the reverse order depending upon the functionality involved.

The method 600 may include the steps of pivoting the tailgate 30 from the upright orientation to the laid-out orientation, as depicted in block 602, and removing original fasteners or other mechanical fasteners from the fastener holes of the interior tailgate cover 32 extending through at least a portion of the tailgate 30, as depicted in block 604. Pivoting the tailgate 30 may include manual or automated actuation of a lock and/or a handle of the tailgate 30, followed by pivoting the tailgate about one or more hinges or the like until it reaches its full laid-out orientation, substantially horizontal to the ground and in alignment with a bed of the vehicle 28. As noted above, the original fasteners or other mechanical fasteners may be located through at least a portion of the tailgate (e.g., through the interior tailgate cover 32) to maintain the interior tailgate cover 32 over interior mechanisms coupled to a handle of the tailgate 30 and/or to cover other such mechanisms within the tailgate 30 for maintaining the tailgate 30 in the upright orientation and releasing the tailgate 30 to pivot downward into the laid-out orientation.

Next, the method 600 may include the steps of opening the lid 14 of the multi-use box 10 into the open position, as depicted in block 606, and placing and/or aligning the base portion 12 onto the tailgate 30 (e.g., onto the interior tailgate cover 32) with the tailgate 30 in the laid-out orientation, as depicted in block 608. Opening the lid 14 may include pivoting the lid 14 about the hinges 16, for example. The order of the steps depicted in blocks 606 and 608 may be reversed without departing from the scope of the invention. The alignment described in block 608 may include positioning the multi-use box 10 such that a perimeter of the base portion 12 all residing inward of a perimeter of the tailgate 30. The hinge 16 (e.g., mechanical or living hinge) or portion about which the lid 14 rotates when opening and closing may be located proximate hinges of the tailgate 30 or conversely opposite thereof proximate an upper or rear-most end edge of the tailgate 30.

This alignment step depicted in block 608 may also include aligning attachment holes (not shown) of the multi-use box 10 with the fastener holes of the interior tailgate cover 32. The attachment holes may be formed during manufacturing of the multi-use box 10, drilled into the multi-use box 10 during installation, and/or may be formed via knockout portions in the base portion 12 that are structurally designed (via perforations or the like) to be pushed or otherwise knocked out of the multi-use box 10 to form the attachment holes. That is, the alignment step depicted in block 608 may, in some embodiments, further include and/or be proceeded by drilling holes through the base portion 12 at a location aligned with fastener holes of the interior tailgate cover 32 or by removing knockout portions of the base portion 12 that are at the location aligned with the fastener holes of the interior tailgate cover 32.

Then once such alignment is achieved, the method 600 may include placing box-attaching mechanical fasteners (e.g., the mounting fasteners 22) through one or more holes formed through the base portion 12 and holes of the interior tailgate cover 32 aligned with the one or more holes of the base portion 12, as depicted in block 610, thus affixing the interior tailgate cover 32 and the base portion 12 of the multi-use box 10 with the outer tailgate cover 34 of the tailgate 30. The step depicted in block 610 may include, for example, inserting or installing the mounting fasteners 22 (e.g., the screws earlier removed or other mechanical fasteners) through the attachment holes in the base portion 12 and the fastener holes in the interior tailgate cover 32, thereby holding the interior tailgate cover 32 and the multi-use box 10 in place relative to the outer tailgate cover 34 opposite the interior tailgate cover 32. The mounting fasteners 22 may be configured to keep the attachment holes formed through the base portion 12 watertight, via a seal, rubber O-ring, or the like.

Furthermore, in some embodiments, the method 600 may include placing the dense foam 24 into the multi-use box 10, as depicted in block 612. However, in other alternative embodiments, the dense foam 24 may be provided by the manufacturer pre-placed and/or pre-secured within the multi-use box 10. Furthermore, in some embodiments the method 600 includes cutting or otherwise forming the dense foam 24, as depicted in block 614, to create the cutouts 26 shaped, sized, and configured for securing particular ones of the tools 27, firearms, weapons, fishing gear, or the like. This may be accomplished with any cutting tools suitable for cutting dense foam and can be accomplished based on drawing outlines around the tools 27 to be included therein or based on pre-provided stencils and/or instructions for removing a proper amount of the dense foam 24 to securely maintain a particular tool or item in each of the cutouts. In some embodiments, the cutouts 26 may also include cutouts positioned and sized to accommodate the latches or locks described herein. Furthermore, in some embodiments, the dense foam 24 may be sized and shaped to secure other toolboxes, tackle boxes, tool-holding trays, or the like that can nest into the dense foam 24.

The method 600 may also include placing and/or securing the tools 27 or other such items (e.g., fishing gear, weapons, firearms) within the multi-use box (e.g., into their respective cutouts 26), as depicted in block 616, pivoting the lid 14 from the open position into the closed position, as depicted in block 618, and engaging the latches or locks to secure the lid in the closed position, as depicted in block 620. Note that other methods of securing the tools 27 or other items in the multi-use box may be used along with the method steps described herein without departing from the scope of the invention. For example, instead of dense foam, in some alternative embodiments, a plastic or rubber may be used with cutouts of various tools or items to be stored therein, and/or with flexible tabs or protrusions to assist in selectively maintain the tools or items in place within the multi-use box 10. In yet another alternative embodiment, clips, straps, and other types of releasable fasteners may be attached to the lid 14 and/or the base portion 12 and may be actuatable to secure the tools 27 or other such items within the multi-use box 10. These releasable fasteners may be in addition to the dense foam 24 or used as an alternative to the dense foam.

Once the lid is secured in the closed position, the method 600 may include a step of pivoting the tailgate 30 from the laid-out orientation to the upright orientation, as depicted in block 622. When the tailgate 30 is in the upright orientation, the multi-use box 10 is located within a trailer bed of the vehicle 28. Using the mounting methods for the multi-use box 10 described herein, the tailgate 30 may be opened and/or closed without needing to remove the multi-use box 10 and without disturbing any of the contents therein. In the embodiments installed onto a pick-up truck, as depicted in FIGS. 2-5, it may be best to open the multi-use box 10 when the tailgate is in the laid-out orientation, as this allows easy access to the tools or items therein.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claim(s) at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed, and substitutions made herein without departing from the scope of the technology as recited in the claims.

1. Method for attaching a multi-use box to a vehicle, the method comprising the steps of:
placing a base portion of the multi-use box against an interior tailgate cover of a tailgate of the vehicle,
placing box-attaching mechanical fasteners through one or more holes formed through the base portion and holes of the interior tailgate cover aligned with the one or more holes of the base portion, affixing the interior tailgate cover and the base portion of the multi-use box with an outer tailgate cover of the tailgate; and
pivoting a lid of the multi-use box from an open position to a closed position.

2. The method of claim 1, wherein the multi-use box is filled with a dense foam.

3. The method of claim 2, wherein the dense foam has cutouts formed therein that are sized and shaped like a peripheral shape or outline of one or more tools, fishing gear, or weapons.

4. The method of claim 3, further comprising forming the cutouts into the dense foam based on templates sized and shaped to accommodate a peripheral shape or outline of the one or more tools, fishing gear, or weapons.

5. The method of claim 4, further comprising securing a plurality of tools, fishing gear, or weapons within the cutouts of the dense foam in the multi-use box.

6. The method of claim 1, further comprising locking or latching the lid of the multi-use box.

7. The method of claim 1, further comprising pivoting the tailgate from a laid-out orientation to an upright orientation, such that the multi-use box is located within a trailer bed of the vehicle.

8. The method of claim 1, further comprising unlatching the tailgate of the vehicle and pivoting the tailgate of the vehicle from an upright orientation to a laid-out orientation prior to placing the base portion of the multi-use box against the interior tailgate cover.

9. The method of claim 1, further comprising removing tailgate mechanical fasteners from the holes of the interior tailgate cover prior to placing the base portion of the multi-use box against the interior tailgate cover.

10. The method of claim 9, wherein the box-attaching mechanical fasteners are at least one of longer and stronger than the tailgate mechanical fasteners.

11. Method for attaching a multi-use box to a vehicle, the method comprising the steps of:
aligning a base portion of the multi-use box against an interior tailgate cover of a tailgate of the vehicle, with the tailgate in a laid-out orientation, such that a perimeter of the base portion completely resides inward of a perimeter of the tailgate;
pivoting open a lid of the multi-use box that is pivotally attached to the base portion;
placing box-attaching mechanical fasteners through one or more holes formed through the base portion and holes of the interior tailgate cover aligned with the one or more holes of the base portion, affixing the interior tailgate cover and the base portion of the multi-use box with an outer tailgate cover of the tailgate;
securing a plurality of tools, fishing gear, or weapons within the multi-use box; and
pivoting a lid of the multi-use box from an open position to a closed position.

12. The method of claim 11, wherein the multi-use box is filled with a dense foam.

13. The method of claim 12, wherein the dense foam has cutouts formed therein that are sized and shaped like a peripheral shape or outline of one or more tools or weapons.

14. The method of claim 13, further comprising forming the cutouts into the dense foam based on templates sized and shaped to accommodate a peripheral shape or outline of the one or more tools or weapons.

15. The method of claim 11, further comprising locking or latching the lid of the multi-use box and pivoting the tailgate from a laid-out orientation to an upright orientation, such that the multi-use box is located within a trailer bed of the vehicle.

16. The method of claim 11, further comprising unlatching the tailgate of the vehicle and pivoting the tailgate of the vehicle from an upright orientation to a laid-out orientation prior to placing the base portion of the multi-use box against the interior tailgate cover.

17. The method of claim 11, further comprising removing tailgate mechanical fasteners from the holes of the interior tailgate cover prior to placing the base portion of the multi-use box against the interior tailgate cover.

18. The method of claim 17, wherein the box-attaching mechanical fasteners are at least one of longer and stronger than the tailgate mechanical fasteners.

19. A multi-use box for attachment to a vehicle tailgate, the multi-use box comprising:
a base portion sized to fit against an interior tailgate cover of the vehicle tailgate such that a perimeter of the base portion completely resides inward of a perimeter of the tailgate;
a lid pivotally attached to the base portion and pivotable from a closed position to an open position;
one or more latches or locks attached to at least one of the base portion and the lid portion and operable to maintain the lid in the closed position;
mechanical fasteners attachable through the base portion and the interior tailgate cover;
a dense foam located within the base portion, with a plurality of cutouts formed therein, sized and shaped like a peripheral shape or outline of one or more tools, fishing gear, or weapons.

20. The multi-use box of claim 19, wherein the base portion has at least two knockout portions or attachment holes formed therethrough at locations that align with at least two pre-existing fastener holes formed through an interior tailgate cover of one or more vehicle tailgates.
